(19) United States
(12) Patent Application Publication
(10) Pub. No.: US 2014/0223387 A1
(43) Pub. Date: Aug. 7, 2014

(54) TOUCH-SENSITIVE DEVICE AND ON-SCREEN CONTENT MANIPULATION METHOD

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW); YI-RU LAI, New Taipei (TW); PO-CHING CHIANG, New Taipei (TW)

(73) Assignee: HON HAI PRECISION INDUSTRY CO., LTD., New Taipei (TW)

(21) Appl. No.: 14/160,567

(22) Filed: Jan. 22, 2014

(30) Foreign Application Priority Data
Feb. 4, 2013 (TW) 102104265

(51) Int. Cl. G06F 3/0488

(52) U.S. Cl. CPC G06F 3/0488
USPC 715/863

(57) ABSTRACT

An electronic device includes a front panel and a side panel. A display is disposed at the front panel and configured to present content to a user. A touch-sensitive bar is disposed at the side panel and configured to receive a touch gesture input by the user. A control module is configured to manipulate the presented content according to the touch gesture. An on-screen content manipulation method is also provided.

### CROSS-REFERENCE TO RELATED APPLICATIONS

This application claims all benefits accruing under 35 U.S.C. §119 from Taiwan Patent Application No. 102104265, filed on Feb. 4, 2013 in the Taiwan Intellectual Property Office. The contents of the Taiwan Application are hereby incorporated by reference.

1. Field

The disclosure generally relates to electronic devices, and particularly relates to touch-sensitive devices and on-screen content manipulation methods.

2. Background

Touch-sensitive devices enable a user to provide input to a computing device by interacting with a touch-sensitive panel or other surface of the device. To manipulate content presented on a screen of a touch-sensitive device, a user has to perform quite a few actions, such as finding corresponding buttons or toolbars and operating these buttons or toolbars based preset rules. However, the conventional on-screen content manipulation method does not take advantage of the touch-sensitive functionality.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a front view of one embodiment of an electronic device.

FIG. 2 is a side view of the electronic device of FIG. 1.

FIG. 3 is a block diagram of one embodiment of the electronic device of FIG. 1.

FIG. 4 is a schematic view of an example of the electronic device receiving an upward slide touch.

FIG. 5 is a schematic view of an example of the electronic device receiving an downward slide touch.

FIG. 6 is a flowchart of one embodiment of an on-screen content manipulation method implemented by the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

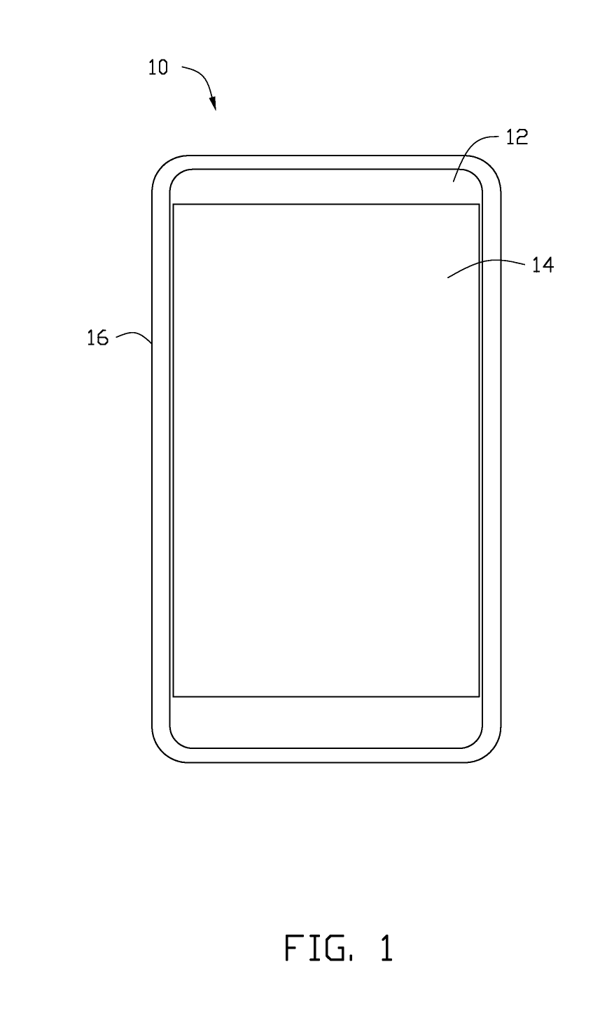

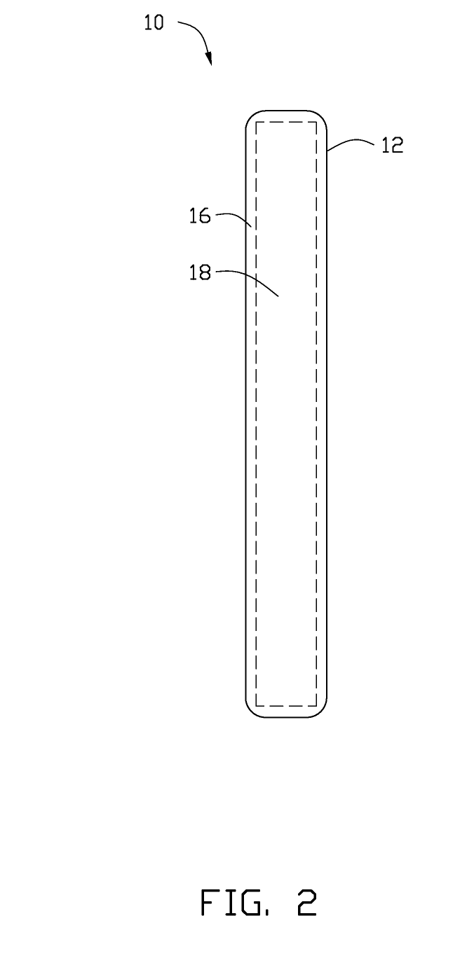

FIGS. 1 and 2 show an embodiment of an electronic device 10. The electronic device 10 includes a front panel 12, a display 14, a side panel 16, and a touch-sensitive bar 18. The side panel 16 is connected to the front panel 12 and substantially perpendicular to the front panel 12. The display 14 is disposed at the front panel 12. The touch-sensitive bar 18 is disposed at the side panel 16.

The electronic device 10 may be realized in any common form factor including, without limitation: a desktop computer, a mobile computer (e.g., a tablet computer, a laptop computer, or a netbook computer), a smartphone, a video game device, a digital media player, or the like.

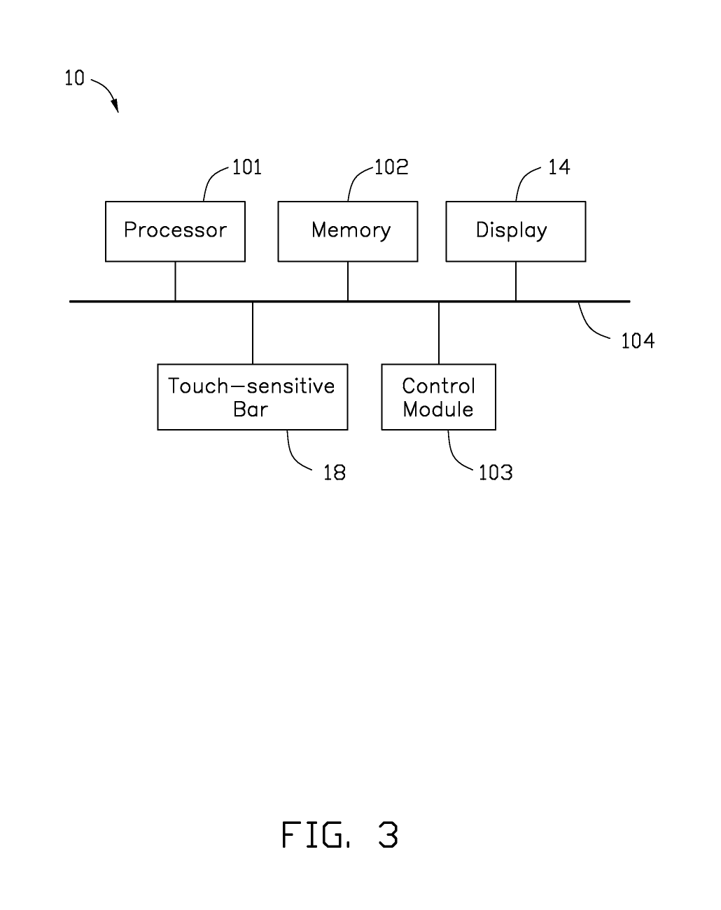

FIG. 3 shows a block diagram of an embodiment of the electronic device 10. The electronic device 10 further includes at least one processor 101, a suitable amount of memory 102, and a control module 103. Of course, the electronic device 10 may include additional elements, components, modules, and be functionality configured to support various features that are unrelated to the subject matter described here. In practice, the elements of the electronic device 10 may be coupled together via a bus or any suitable interconnection architecture 104.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 14 is suitably configured to enable the electronic device 10 to render and display various screens, GUIs, GUI control elements, menus, texts, images, or the like. Of course, the display 14 may also be utilized for the display of other information during the operation of the electronic device 10, as is well understood.

The touch-sensitive bar 18 may detect and recognize touch gestures input by a user of the electronic device 10. The touch-sensitive bar 18 includes a touch-sensitive surface. In one embodiment, the touch-sensitive surface of the touch-sensitive bar 18 is made from carbon nanotubes. The touch-sensitive bar 18 is elongated in a lengthwise direction of the side panel 16. In one embodiment, an area of the touch-sensitive bar 18 is substantially the same as an area of the side panel 16.

The control module 103 may manipulate the content presented by the display 14 according to the touch gestures received by the touch-sensitive bar 18.

When a landscape orientation of the presented content is substantially parallel to a lengthwise orientation of the touch-sensitive bar 18, the control module 103 is configured to move the presented content in the landscape orientation. When a portrait orientation of the presented content is substantially parallel to a lengthwise orientation of the touch-sensitive bar 18, the control module 103 is configured to move the presented content in the portrait orientation.

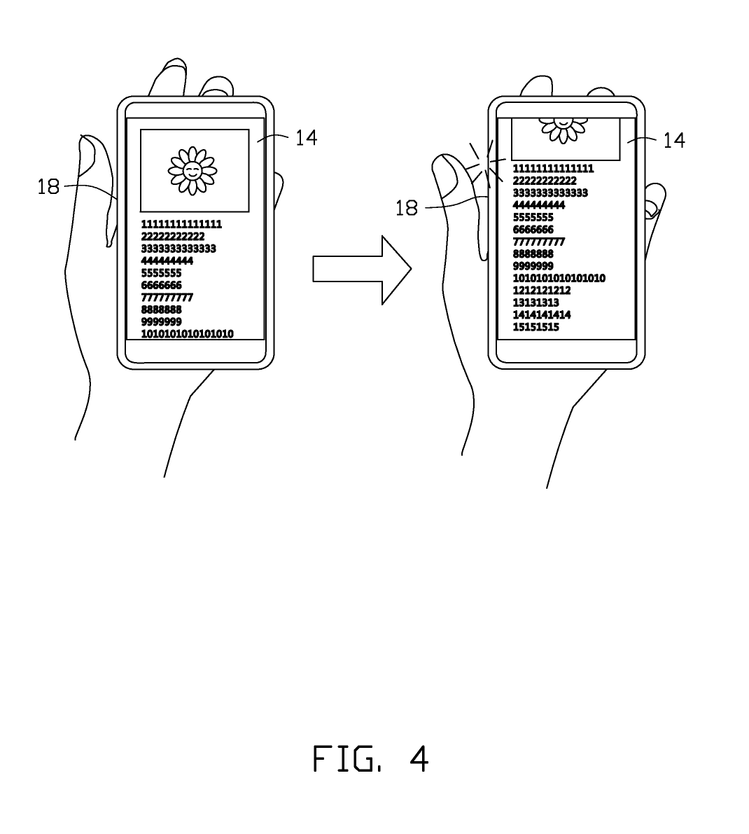

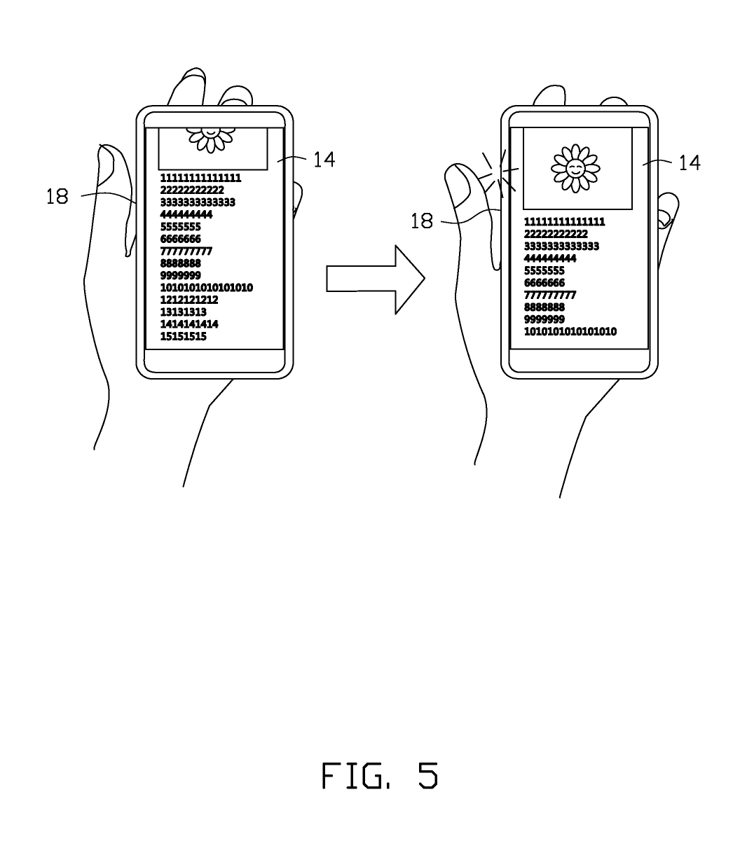

FIGS. 4 and 5 show that, the portrait orientation of the presented content is parallel to the lengthwise orientation of the touch-sensitive bar 18, for example. When the user makes an upward slide touch with respect to the touch-sensitive bar 18, the control module 103 moves the presented content upwards. When the user makes a downward slide touch with respect to the touch-sensitive bar 18, the control module 103 moves the presented content downwards.

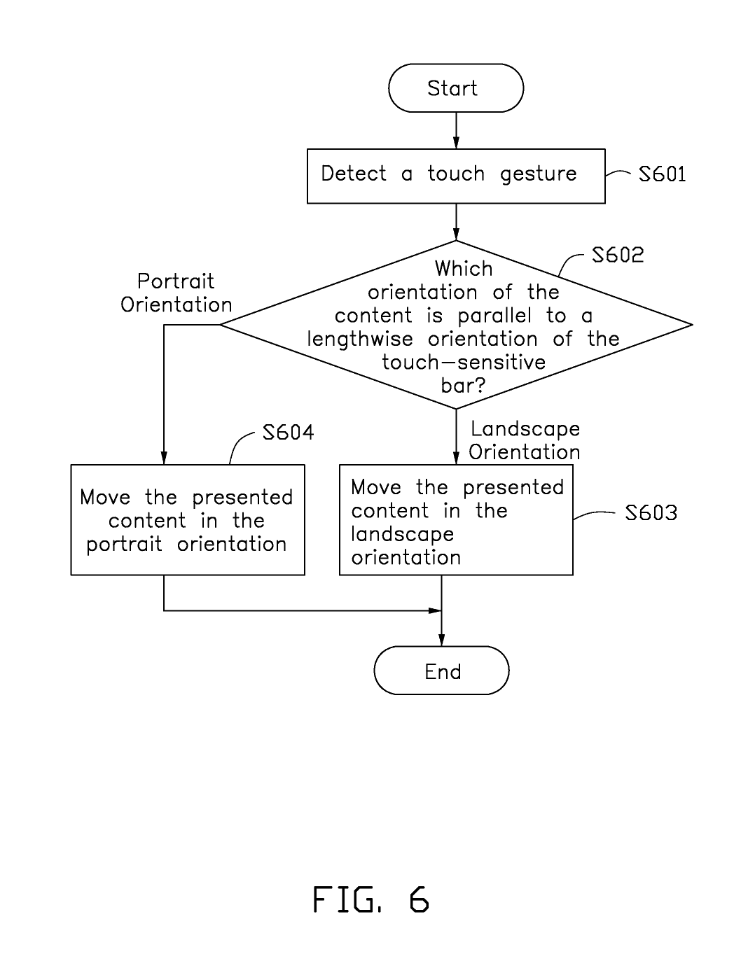

FIG. 6 shows a flowchart of one embodiment of an on-screen content manipulation method implemented by the electronic device 10. The method includes the following steps.

In step S601, the touch-sensitive bar 18 detects a touch gesture which includes a slide touch input by the user.

In step S602, the control module 103 determines which orientation of the presented content is parallel to the lengthwise orientation of the touch-sensitive bar 18. If the landscape orientation of the presented content is parallel to the lengthwise orientation of the touch-sensitive bar 18, the flow proceeds to step S603. If the portrait orientation of the presented content is parallel to the lengthwise orientation of the touch-sensitive bar 18, the flow proceeds to step S604.

In step S603, the control module 13 moves the presented content in the landscape orientation.

In step S604, the control module 13 moves the presented content in the portrait orientation.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a front panel;
a side panel connected to the front panel;
a display disposed at the front panel and configured to present content to a user;
a touch-sensitive bar disposed at the side panel and configured to receive a touch gesture input by the user; and
a control module configured to manipulate the presented content according to the touch gesture.

2. The electronic device of claim 1, wherein when a landscape orientation of the presented content is substantially parallel to a lengthwise orientation of the touch-sensitive bar, the control module is configured to move the presented content in the landscape orientation.

3. The electronic device of claim 1, wherein when a portrait orientation of the presented content is substantially parallel to a lengthwise orientation of the touch-sensitive bar, the control module is configured to move the presented content in the portrait orientation.

4. The electronic device of claim 1, wherein an area of the touch-sensitive bar is substantially the same as an area of the side panel.

5. The electronic device of claim 1, wherein the touch-sensitive bar comprises a touch-sensitive surface made from carbon nanotubes.

6. The electronic device of claim 1, wherein the side panel is substantially perpendicular to the front panel.

7. The electronic device of claim 1, wherein the touch-sensitive bar is configured to receive a slide touch.

8. The electronic device of claim 1, wherein the touch-sensitive bar is elongated in a lengthwise direction of the side panel.

9. An on-screen content manipulation method, the method comprising:
providing an electronic device comprising a front panel, a side panel connected to the front panel, a display disposed at the front panel, and a touch-sensitive bar disposed at the side panel;
presenting content to a user by the display;
receiving a touch gesture input by the user by the touch-sensitive bar; and
manipulating the presented content according to the touch gesture.

10. The method of claim 9, wherein manipulating the present content further comprises, when a landscape orientation of the presented content is substantially parallel to a lengthwise orientation of the touch-sensitive bar, moving the presented content in the landscape orientation.

11. The method of claim 9, wherein manipulating the present content further comprises, when a portrait orientation of the presented content is substantially parallel to a lengthwise orientation of the touch-sensitive bar, moving the presented content in the portrait orientation.

12. The method of claim 9, wherein an area of the touch-sensitive bar is substantially the same as an area of the side panel.

13. The method of claim 9, wherein the touch-sensitive bar comprises a touch-sensitive surface made from carbon nanotubes.

14. The method of claim 9, wherein the side panel is substantially perpendicular to the front panel.

15. The method of claim 9, wherein receiving a touch gesture comprises receiving a slide touch made with respect to the touch-sensitive bar.

16. The method of claim 9, wherein the touch-sensitive bar is elongated in a lengthwise direction of the side panel.
